(19) United States
(12) Patent Application Publication
(10) Pub. No.: US 2003/0232317 A1
(43) Pub. Date: Dec. 18, 2003

(54) Method of presenting an assessment

(76) Inventor: Richard J. Patz, Aptos, CA (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/419,811

(22) Filed: Apr. 22, 2003

Related U.S. Application Data
(60) Provisional application No. 60/452,953, filed on Mar. 10, 2003.
(60) Provisional application No. 60/374,146, filed on Apr. 22, 2002.

(51) Int. Cl. G09B 3/00; G09B 7/00

(52) U.S. Cl. 434/353; 434/322; 434/362

(57) ABSTRACT

A methodology and system for presenting an assessment includes forming short supplemental assessment forms including NRT items, field test items, and anchor equating items from large groups of such items. Different supplemental assessment are incorporated with a common operational form that is administered to all students of a group of students to form an administered form. The administered forms are presented to the group of students in such a manner that different subgroups of students will take an administered form having a different supplemental form embedded therein.

This application claims the benefit of U.S. provisional application serial Nos. 60/374,146 filed Apr. 22, 2002 and 60/452,953 filed Mar. 10, 2003, the contents of which are hereby incorporated by reference.

### BACKGROUND

1. Field of the Invention

The present invention is directed to a methodology for deriving information based on a large number of test items by administering only subsets of the large number of test items to different groups of students as short, supplemental forms embedded with a full operational test taken by all students.

2. Description of the Related Art

Administering a standardized testing program involves presenting a common test form—referred to herein as an operational form—to every student within a particular group, usually a particular grade. The administration of a standardized testing program to groups of students is intended to provide information on a number of different levels and for a number of different purposes. Individual test scores provide an indication of individual students' levels of achievement, usually relative to a particular, predefined academic standard. If the testing program includes a norm-referenced test (NRT) component—i.e., a component that compares a student or group of students with a specified reference group, usually others of the same grade or age—test results can be used for deriving meaningful information regarding trends in student achievement, e.g., from grade to grade and from year to year. A test administration may also be employed as an opportunity to “try out” recently developed and/or modified test items before using the items on the operational portion of the test. This is referred to as field testing. As it is often desirable to present different operational forms from year to year, it is necessary to equate the operational form given one year with the forms given in previous and subsequent years so that administrators can make a determination as to whether a change in test performance from one year to the next for the same group (i.e., grade) is due to an actual change in achievement level attained by the students or a change in difficulty in the operational test form from one year to the next. Other test items may be included in a testing program to support other research.

There are many ways to administer an assessment program when parallel operational test forms are available. In this section we briefly review some of the most common approaches.

Constant Form. Some states or jurisdictions will choose to repeatedly use the same operational test form through the life of a testing program, even when alternative forms are available. Using a constant test form may appear to simplify interpretation of test score changes to a significant extent, although the validity of interpretations of test score changes is somewhat undermined due to increasing exposure of test content over time.

Sequential Administration of Nationally Equated Alternate Forms. Some states or jurisdictions will choose to administer a different, nationally normed and equated operational test form each year. A state or jurisdiction could choose to adopt this approach using, for example, three different forms in each of three consecutive years. If no content is common between the different forms, this approach eliminates the risk associated with exposure of test content in repeated operational test administrations. One limitation of this approach, however, is that appropriate interpretation of year-to-year changes must account for the inherent uncertainty (i.e., “equating error”) involved in estimating the statistical relationship between different test forms administered in different years. One factor that contributes to equating error is the state-by-form interaction, which characterizes the extent to which the national form-to-form equating relationship differs from the form-to-form equating relationship within a particular state. In the sequential administration of nationally equated alternate forms, the state-by-form interaction cannot be estimated (it is statistically confounded with year-to-year changes in achievement). Thus, it becomes impossible to accurately determine the extent to which year-to-year changes are due to actual changes in achievement or equating errors.

Simultaneous Administration of Alternate Forms. It is possible to administer multiple operational forms simultaneously by spiraling the multiple forms so that different students take different forms. For example, if there are three forms, they are administered so that every 3^{rd} student receives the same form. This approach allows for the estimation and possible elimination of state-by-form interactions. Because students taking different forms receive comparable scores, the equating assumptions are relied upon very heavily. This approach is most commonly employed where the focus of attention rests above the level of the individual student (e.g., classrooms, schools, or districts). Finally, because all forms are administered each year, this exposure must be considered when interpreting year-to-year changes. However, the more forms you have, the less likely it is that you will teach to the test.

Constant Trend Forms with Low Exposure. It is possible to identify or create a set of forms to be used exclusively for the purpose of tracking population trends in achievement over time. Census administration of these forms to all students in a jurisdiction is neither required nor desirable. Instead, the trend forms may be administered each year to a statistically representative sample of students. The National Assessment of Educational Progress (NAEP) employs constant trend forms with low exposure to track long-term and intermediate-term trends in national and state achievement.

The administration of short tests covering a broad range of content has been used in many contexts. As opposed to giving the same test to each student of a defined group of students, such short tests have been administered in a spiraled manner in the sense that different short tests are administered to each student of different subgroups of the larger group of students. It is commonly used in state assessment programs to obtain field test information while minimizing the burden of additional testing time. The approach has also been used in testing programs when the focus of attention is at the school, district or state level. This is the approach used for anchor equating research in the Maryland State Performance Assessment Program (MSPAP; Yen and Ferrara 1997). The prior approach used in Maryland did not, however, employ short, spirally-administered tests to conduct NRT trend analysis or field testing of items for possible future use. The Maryland approach also did not involve the administration of a common operational form to all the students of the group in combination with one of the short spiraled tests and thus did not support reporting of individual student results. As mentioned above, spiraled administration of short forms is also employed by the National Assessment of Educational Progress (NAEP) in its partially balanced incomplete block design (see for example, Johnson, Mazzeo, and Kline, 1995). NAEP accomplishes alignment of its state and national results by a linear equating transformation. NAEP does not, however, combine spiraled administration of different short tests with a census administration of a common operational form to all students of the group of students. As with the Maryland approach, therefore, NAEP does not provide data for reporting individual student results.

### SUMMARY OF THE INVENTION

The present invention provides a testing approach utilizing norm-referenced test (“NRT”) trend forms embedded in operational test forms. In the context of the present invention, an operational form is a form that is administered, in census fashion, to each student of a relatively large group of students. Different norm-referenced trend forms are administered in spiraled fashion to discreet subgroups of the large group of students by embedding one of the supplemental forms to the common operational form. Thus, a large number of NRT items can be administered to a large group of students by breaking the large number of items into a number of shorter supplemental forms and combining one of the supplemental forms to each of the common operational forms administered to all students in the large group. Thus, the large number of items is administered to the large group of students, but each student only takes a small subset of the large number of items, as contained in the supplemental form appended to that student's common operational form. The methodology supports the reporting of individual student results, via the common operational form, and detailed group-wide trend results via the large number of NRT items administered via the supplemental trend forms.

Similarly, large numbers of field testing and/or anchor equating items can be subdivided into supplemental field test and/or anchor equating forms that can be embedded with the common operational form to support further group-wide research and equating along with the individual reporting supported by the operational form.

### DESCRIPTION OF THE DRAWINGS

FIG. 1 schematically represents the subdivision of a large number of test items into a plurality of supplemental forms, each containing a smaller number of items.

FIG. 2 schematically represents the embedding of a different supplemental form to each operational form to construct an administered form.

FIG. 3 schematically represents the spiraling of different administered forms based on the different supplemental forms embedded with the common operational forms.

FIG. 4 schematically represents the prior art concept of item overlap from year-to-year operational forms to provide year-to-year anchor equating.

FIG. 5 schematically represents the method of using supplemental forms embedded in the common operational form for anchor equating and trend analysis.

### DETAILED DESCRIPTION OF THE INVENTION

In accordance with an exemplary implementation of the present invention, all students receive a common operational test form on which individual student scores are based. The common operational test form may include NRT and/or standards-based components. In addition, the invention presents a unique design and administrative approach for deriving trend data and for gathering certain research information (including field test information) in addition to the individual scores derived from the operational test.

The characteristics of the approach include:

A single set of operational test forms, common to all students of a specified group of students (e.g., a grade), including, for example, NRT and/or standards-based components.

A large set of short, e.g., 20-item, supplemental forms, one short form being incorporated (i.e., embedded in and/or appended to) with each operational form.

Content in the short supplemental forms consists of items to be field tested, anchor items from previous administrations (discussed in more detail below), and/or items comprising NRT trend forms. In addition, the content of the short supplemental forms may consist of items that support other research.

The incorporated supplemental forms will vary from one student to the next (i.e., they will be spiraled). Some of these spiraled supplemental forms consist of portions of one or more full trending forms delivered in short (e.g., 20-item) sets and administered across a large number of students. These supplemental trend forms will provide the testing jurisdiction with NRT trend data. These spiraled supplemental trend forms allow for the year-to-year (horizontal) and grade-to-grade (vertical) comparisons of test results and trends. Some incorporated supplemental forms may contain new items to be field-tested, and some supplemental forms may contain anchor items for equating.

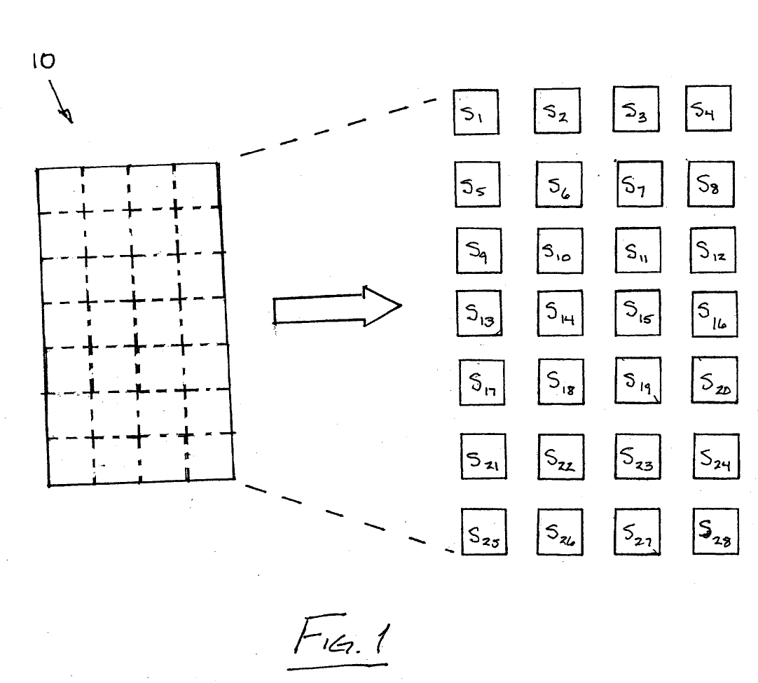

Preferably, each testing purpose (i.e., field testing, anchoring, and/or NRT trending) will be covered in two or more supplemental forms for each content area (e.g., reading, mathematics, science, etc.), each containing a number of unique items related to the content area. A larger set of items is subdivided into discrete supplemental forms, each preferably having an equal number of unique items. This is schematically represented in FIG. 1 in which a large body of items 10 is subdivided into a plurality of short, supplemental forms S₁, S₂, S₃, . . . S₂₈. Body of items 10 may represent an item bank containing a relatively large number of items correspond to a particular content area, such as field test items, NRT trending items, or anchor items. In an exemplary implementation of the invention, the body of items constitutes, or is derived from, one or more nationally standardized forms of varying length. Alternatively, body 10 may represent one or more previously developed operational NRT trend forms which may or may not have been administered to students as operational tests in the past. The body of items 10 is preferably divided into supplemental forms S₁, S₂, S₃, . . . having equal numbers of items per form. For example, if the body 10 contains 560 items, it may be subdivided into twenty-eight supplemental forms S₁, S₂, S₃, . . . S₂₈, each having 20 items.

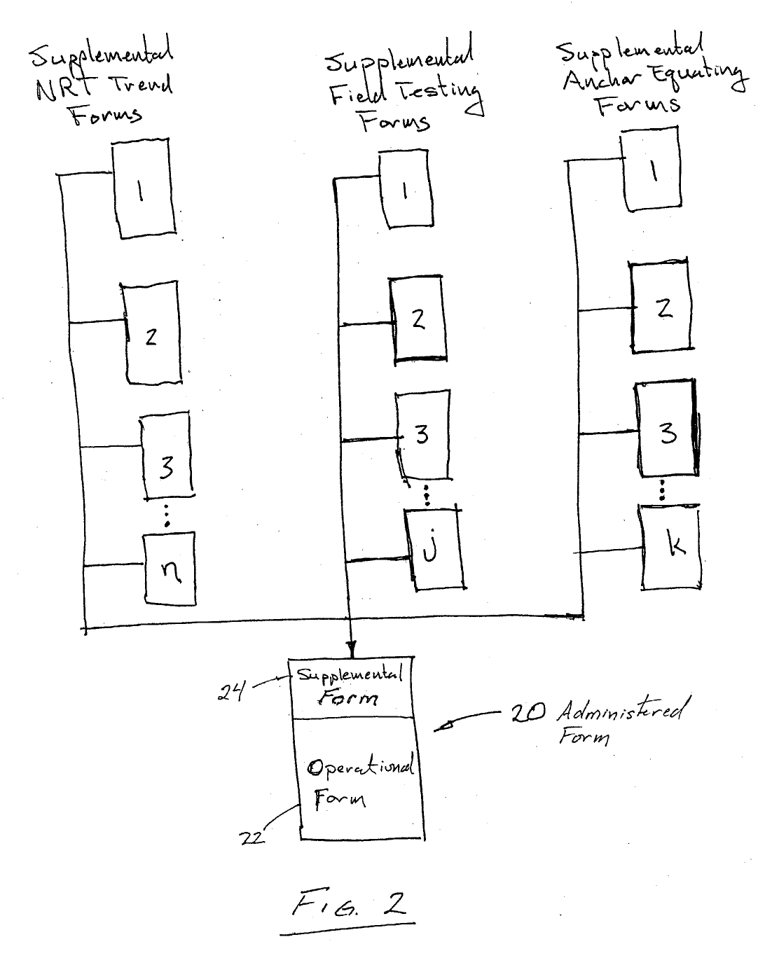

Thus, a large set of NRT items is subdivided into two or more supplemental NRT forms, a large set of field test items is subdivided into two or more supplemental field test forms, and a large set of anchor equating items is subdivided into two or more supplemental anchor equating forms. At least one supplemental form—and preferably only one supplemental form—is combined with a common operational form to create an administered form that will be administered to all students within a specified group. This is schematically represented in FIG. 2 in which one of the supplemental NRT trend forms 1−n, one of the supplemental field testing forms, 1−j, or one of the supplemental anchor equating forms 1−k is combined—as represented at 24—with the common operational form 22 to form the administered form 20.

Different subgroups of students will get a different one of the supplemental forms (although it is not necessarily required that every student get a supplemental form) so that, over the entire student population statistically significant (and preferably statistically equal) numbers of students will get each of the supplemental forms. Consequently, field testing, NRT trending, and anchor equating can be conducted on the basis of the larger sets of items corresponding to that content area without requiring any students to actually have to take all the items corresponding to a content area. Each student to whom a supplemental form is given only takes the subset of items (field test, NRT trending, and/or anchor equating) of that supplemental form.

We refer to the approach of incorporating supplemental forms into full operational assessment forms as “robust spiraled embedding.”

Embedding communicates that the supplemental content is incorporated seamlessly with operational student test books as a separate, short test section.

Spiraling indicates that the test books containing different incorporated supplemental forms are assembled in sequential order at the manufacturing stage so that the existence of multiple supplemental forms does not create any logistical difficulties during administration, and so that the samples of students encountering the different forms are statistically equivalent. In the preferred implementation, spiraling occurs at the student level where possible and at a more macro level, such as classroom or school level, where necessary (e.g., where instructions specific to the items in the supplemental forms needs to be provided to the group of students).

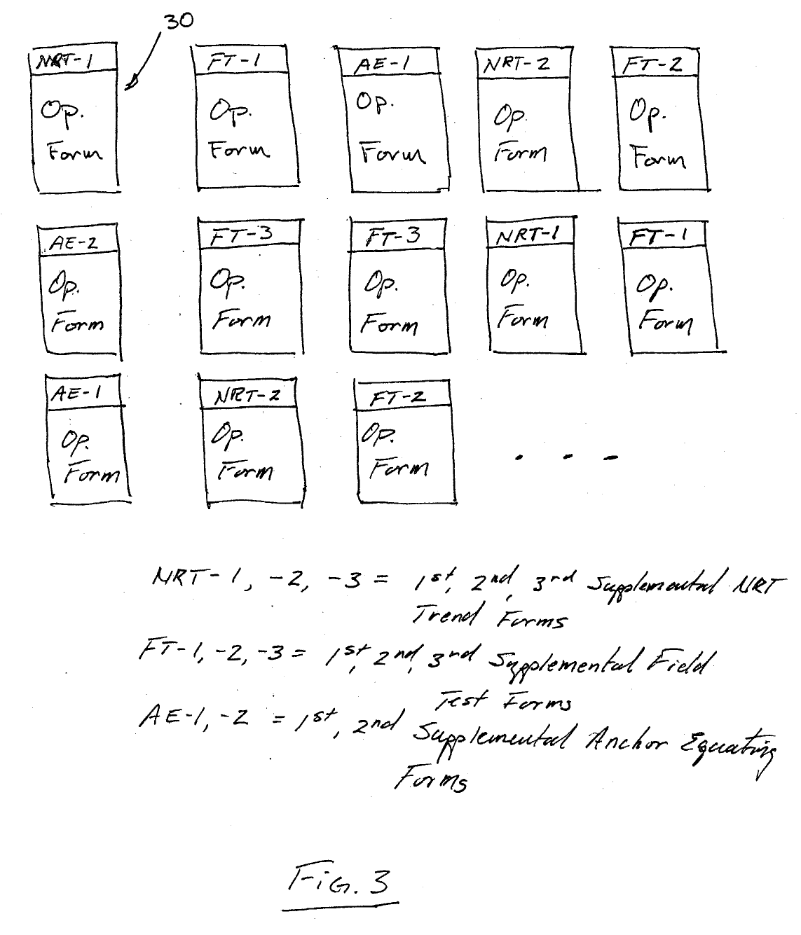

An exemplary method of spiraling is schematically shown in FIG. 3 in a test administration in which a group of NRT trending items has been subdivided into three supplemental NRT trend forms NRT-1, NRT-2, and NRT-3; a group of field test items has been subdivided into three supplemental field test forms FT-1, FT-2, and FT-3; and a group of anchor equating forms has been divided into two supplemental forms AE-1 and AE-2. Test booklets 30 are prepared such that each booklet 30 includes an operational form and a one of the supplemental forms. The first three booklets (starting at the upper left-hand comer and going from left to right) include an operational form and the first supplemental forms NRT-1, FT-1, and AE-1, respectively. The next three test booklets include an operational form and the second supplemental forms NRT-2, FT-2, and AE-2, respectively. The next two test booklets include the third supplemental forms NRT-3 and FT-3, with the anchor equating supplemental form being skipped because there are only two supplemental anchor equating forms. This pattern repeats itself for each subsequent set of eight test booklets.

Finally, the approach is robust in at least two distinct ways: 1) the breadth of information that may be gathered using the approach is very significant, and may include at a minimum all field testing of standards-based test items, equating of standards-based forms, and norm-referenced trend information; and 2) the very solid data gathered to support meaningful inferences regarding trends in achievement will be easily interpreted and not particularly sensitive to the choice of statistical methodology. By carefully specifying the content of the embedded short forms and their arrangement in combination with operational forms, the present invention will provide a number of benefits.

Very robust NRT trend information, based on a large, consistent, and secure (i.e., low exposure because different groups of students get different NRT supplemental forms) set of NRT items, that augments the reporting of highly reliable individual norm-referenced scores.

Because each student gets one supplemental form in addition to the operational form, no student is required to take every field test item, every NRT item, and/or every anchor item. Moreover, to the extent that field testing, NRT trending, and/or anchor equating can be performed on the basis of supplemental forms, items corresponding to those content areas can be eliminated or at least reduced from the operational forms. Thus, the approach allows very efficient use of student test time and supports a strategy to dramatically reduce student test time by eliminating redundant measurement in the operational forms.

Very solid year-to-year equating of the operational standards-based forms that will allow operational forms to be released to the public each year, because anchor items can be kept as secure supplemental forms used year after year rather than as part of the operational form. This facilitates more open communication with stakeholders (e.g., students, parents, teachers, administrators) regarding the content of the operational assessments.

Ability to accurately track the growth of students from year-to-year on standards based items, including the equating of adjacent grade levels of the standards. Known as “vertical scaling,” this research will allow a jurisdiction to accurately distinguish the relative difficulty of standards across grades, so that changes in student proficiency and changes in standards difficulty may be separately identified. It allows, but does not require, reporting along a longitudinal scale that spans grades.

A simple, consistent, design approach that transparently facilitates ongoing field testing and the capability to easily engage in research that is responsive to evolving policy needs. The need for separate field testing is eliminated where field testing content can be incorporated into supplemental forms., and there is the ability to link different tests by embedding content from the different tests in the set of 20-item supplements.

In one implementation of the invention, we 1) re-configure the content in two different full, operational NRT forms of an achievement test (referred to as forms B and D) into short (e.g., 20-item) supplemental NRT trend forms that are incorporated in spiraled fashion into a full, operational NRT test (referred to as form C) that will be administered to all students, where forms B, C, and D are operational forms that had previously been designed to be administered sequentially or simultaneously and each of forms B, C, and D is intended to be administered to each student of a group of students as a common operational test to measure individual students on a set of predefined academic standards; 2) re-equate the newly configured supplemental trend forms derived from forms B and D to the intact, nationally normed operational NRT test, form C; and 3) re-administer the supplemental trend forms derived from forms B and D annually while reducing the length of the NRT portion of the common operational form in years subsequent to re-equating. Thus, in the previous example, form C is the operational form administered to all students of a particular group of students, and forms B and D together define the body of items that is subdivided into short supplemental forms incorporated with form C to create an administered form.

In accordance with a feature of the present invention, the breadth of content covered by the supplemental NRT trend forms at any given grade is improved by the inclusion of supplemental trend forms derived from full NRT trend forms associated with adjacent grade levels. For example, in addition to 4^{th} grade supplemental NRT forms, some 3^{rd} and 5^{th} grade supplemental NRT forms will be administered to 4^{th} grade students, thereby increasing the number of NRT supplemental forms (and thus the number and breadth of NRT items) administered for 4^{th} grade NRT trending.

If desirable, short, supplemental trend forms can be equated to a full, nationally or otherwise standardized test so that equating relationships between the short, supplemental forms and full operational forms can be derived. Although typically the full NRT form(s) from which the supplemental forms are subdivided may already be equated to the full operational form, the re-configuration of the full NRT form(s) content into short, supplemental trend forms require the re-equating of the supplemental forms to the full NRT form to account for the different context effects. In the implementation describe above, the short, supplemental forms derived from operational forms B and D are equated to the intact operational form C. Because the short supplemental forms are administered in the same configuration from test administration to test administration, it is not necessary to re-equate the supplemental forms for subsequent years following the initial equating. Also, once the supplemental NRT forms have been equated to a full operational NRT form, it is no longer necessary to derive NRT trend data from the operational test, and the NRT component of the operational test can be reduced or eliminated.

It is contemplated that in the first year of administering forms presented in accordance with the present invention by incorporating one or more previously-equated full NRT forms reconfigured as sub-divided short, supplemental trend forms, it is also necessary to administer the full operational NRT trend form and then equate the supplemental trend forms derived from the full NRT form(s) to the full operational NRT form. To be precise, the population mean and standard deviation for each grade and content area derived from the set of supplemental trend forms are matched (by linear equating transformation) to the population mean and standard deviation derived from a census administration of the full operational NRT trend form. In subsequent years, no additional equating is needed since the supplemental trend forms are re-administered in the same configuration and thus the equating relationships between the supplemental trend forms and the full operational form continue to apply. Furthermore, it is noteworthy that the value of the information provided by the supplemental trend forms is not particularly sensitive to the choice of equating methodology, since a large set of common items is, via the supplemental trend forms, administered year-after-year with a low rate of exposure to representative samples of the jurisdiction's population of students. This provides highly valuable information for tracking detailed trends in achievement in the jurisdiction.

Unlike prior art administrations of short spiraled forms, the use of spiraled, embedded NRT trend forms is intended to supplement, rather than to replace, the administration of a common operational form, so that comparable individual student results can be reported along with information derived from the supplemental forms for state-level analysis. That is, reportable information regarding achievement comes from an administered form that includes an operational form common to all students of a specified group and different spiraled NRT forms. The NRT portion of the common operational form provides information supporting the reporting of individual NRT data, and the short NRT supplemental form provides information for trend analysis across the group of students. The use of short supplemental forms provides more detailed information for group-wide trend analysis than simply relying on the NRT portion of the common operational form. This can be best illustrated by an example. The NRT portion of the common operational form may comprise 50 questions, and, of course, each student in the tested group gets the same 50 questions. Therefore, group-wide trend analysis based on the results on the common operational form would be based only on those 50 questions. On the other hand, if a group of 500 NRT items were divided into twenty-five 20-item supplemental forms, each of the supplemental forms can be administered to statistically relevant subgroups of the tested group. The group-wide trend analysis would then be derived from the responses on 500 NRT items (a ten-fold increase over the common operational form) without substantially increasing the testing burden on any one student.

Preferably, the use of a single, common form for census administration will continue, and this will to be the basis for student level reporting. However, the use of supplemental trend forms incorporated into the common form for state-trend data reduces the need to test all students as extensively with the operational NRT common form because trend data for certain content areas can be derived from the supplemental forms. For example, trend data relative to achievement standards such as vocabulary, language mechanics, mathematics computation, and spelling can be derived from appropriate supplemental tests administered to a small, but statistically significant portion of the student population. Thus, not all students need to be tested on these standards in the common operational test, thereby reducing the time spent testing.

Embedding Field Test Content in a Subset of Operational Forms

In accordance with the present invention, field test items contained in a supplemental form are embedded on a subset of the operational test forms and administered to a representative sample of students selected to take the field test items. All other students will take the standard operational forms without embedded field test supplemental forms (they may have embedded NRT or anchor equating supplemental forms).

Field-testing items this way provides all the statistical information needed, while significantly keeping costs and additional student testing time down. With this plan, the majority of students will see no additional testing time requirements for field-testing of items. And those students selected to take the embedded field test forms will see only a 15% increase in testing time.

Equating of Forms

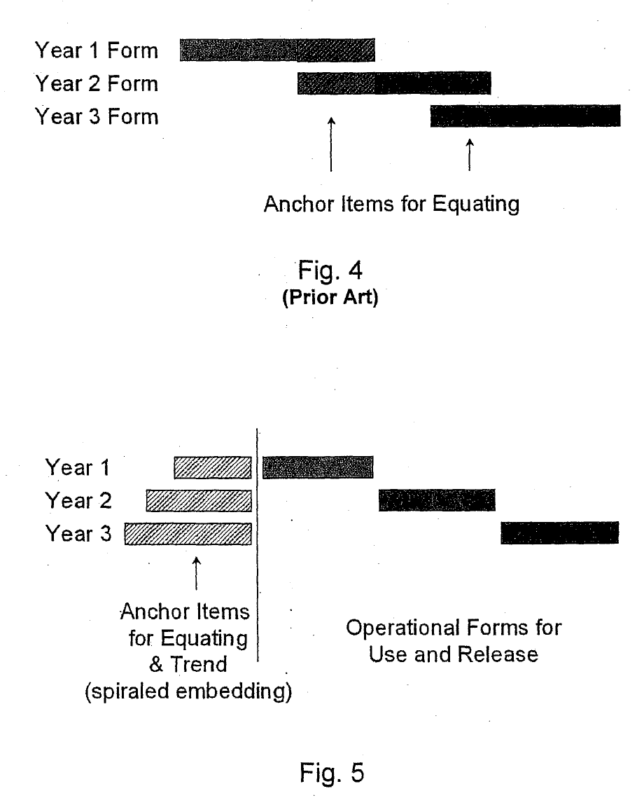

A conventional equating design for standards-based tests is based on the embedding of common (i.e., “anchor”) items in adjacent years of the testing program. This conventional design is schematically illustrated in FIG. 4. A portion of the items of the year 1 operational form (represented by a horizontal bar) overlaps a portion of the items of the year 2 operational form. These common, overlapping items are used to equate the year 1 operational form to the year 2 operational form. Similarly, a portion of the items of the year 2 operational form overlaps a portion of the items of the year 3 operational form, and these common, overlapping items are used to equate the year 2 operational form to the year 3 operational form. This approach, however, does have its drawbacks. In particular, the repeating of items from one year to the next creates a test security concern, and it prevents the release of intact test forms.

The desire to bring greater transparency into a standards-based testing program, and to allow annual release of intact operational forms in particular, would necessitate a change to the equating design. The invention employs an equating design based on the annual embedding of anchor forms within the operational forms. This embedding of anchor forms is one part of the robust spiraled embedding approach, described in the context of field test design above.

The equating of an operational form to a set of anchor forms has been performed before by CTB-McGraw-Hill, the assignee of the present invention. Anchor forms have not, however, been employed as part of an overall testing system and methodology that combines the use supplemental anchor forms seamlessly embedded into a common operational form along with supplemental forms for other reporting (e.g., NRT trends) and research (e.g., field testing).

As schematically illustrated in FIG. 5, common anchor items are administered year-after-year as supplemental forms incorporated in spiraled fashion into operational forms. Anchor equating using supplemental forms allows the annual release of intact operational forms because there is no year-to-year overlap among the operational forms. Furthermore, it is possible to include and equate new equating forms, thus allowing more robust equating over time as the number of equating forms increases. This can be accomplished without increasing testing time because the number of equating items administered to any one student via a supplemental equating form does not increase.

It is preferred that anchor forms be administered (via spiraled embedding) at adjacent grade levels. This will provide the state the ability to accurately track the growth of students from year-to-year on state standards. Known as “vertical scaling,” this research will allow the state to accurately distinguish the relative difficulty of standards across grades, so that changes in student proficiency and changes in standards difficulty may be separately identified. It allows but does not require reporting along a longitudinal scale that spans grades. In combination with the field testing, anchor equating, and NRT trend tracking, vertical scaling will facilitate the more efficient use of field test data, including the eventual use of items originally targeted for an adjacent grade level.

What is claimed is:

1. A method of administering an assessment comprising:
providing an operational assessment form including a plurality of assessment items;
providing two or more different supplemental assessment forms, each of the different supplemental assessment forms comprising a different set of assessment items, whereby all of the assessment items of one supplemental assessment form are not common with all of the assessment items of another, different supplemental assessment form, wherein the assessment items comprising each of the supplemental assessment forms include at least one NRT item; and
including one of the different supplemental assessment forms with each of a plurality of the operational assessment forms to be administered to each of a plurality of test-takers to form a plurality of administered assessment forms, each administered assessment form comprising the operational assessment form and a one of the two or more different supplemental assessment forms, so that administered assessment forms having the same supplemental assessment form are administered to unique subsets of the plurality of test-takers.

2. The method of claim 1, wherein the assessment items comprising each of the supplemental assessment forms include at least one field test item.

3. The method of claim 1, wherein the assessment items comprising each of the supplemental assessment forms include at least one anchor item.

4. A method for determining trends in academic achievement for a group of students comprising:
providing a set of one or more complete test forms intended to be administered to each student of a group of students to measure individual student achievement relative to a set of predefined academic standards;
reconfiguring the set of complete test forms into two or more short forms, each consisting of a unique subset of the items taken from the set of complete forms;
administering the short forms to the group of students such that each of the short forms is administered to a statistically relevant number of students comprising a unique subset of the group of students; and
determining trends in academic achievement for the group of students relative to the predefined academic achievement standards based on the performances of all the unique subsets of students on the short forms.

5. The method of claim 4, wherein the set of complete test forms is divided into n unique short forms, and wherein the short forms are administered such that every n^{th} student receives the same short form.

6. The method of claim 4, wherein each short form is incorporated with a common operational assessment form that is administered to all students of the group.

7. The method of claim 4, wherein the group of students comprises students within a particular academic grade and a unique set of complete test forms is associated with each academic grade of students from whom trends are to be determined.

8. The method of claim 7, wherein the short forms are administered so that at least a portion of the students within a particular academic grade receive a short form consisting reconfigured from the set of complete test forms associated with an academic grade that is different from the particular academic grade.

9. The method of claim 8, wherein the different academic grade is one grade above or one grade below the particular academic grade.

10. The method of claim 4, further comprising equating the two or more short forms to a complete test form intended to be administered to each student of a group of students to measure individual student achievement relative to a set of predefined academic standards.

11. A method of administering an assessment to a group of students comprising:
administering a common assessment form to all students in the group of students; and
administering a supplemental form to each of at least a portion of the students, the supplemental form being incorporated with the common assessment form administered to the portion of students, wherein different supplemental forms are administered to each of different groups of students of the portion of students, and wherein the supplemental forms administered to each of the groups of students comprise one of:
(a) one of two or more NRT forms each consisting of a plurality of unique NRT items selected from a collection of NRT items for assessing trends in student academic achievement relative to predefined academic achievement standards;
(b) a form containing items being field tested for possible use on future common assessment forms; and
(c) a form containing a set of anchor items for equating the performance results of the students on the common form with the performance results of a different group of students on a different common form, a portion of which are administered a supplemental form containing the same anchor items.

12. The method of claim 11, wherein the collection of NRT items comprises a set of one or more complete test forms intended to be administered to each student of a group of students to measure individual student achievement relative to a set of predefined academic standards.

13. A system for testing a group of students comprising:
a single set of operational test forms common to all students of the group of students for providing an individual test score for each student based on that student's performance on the operational test form; and
a set of different supplemental test forms, one of the different supplemental test forms being incorporated into each of the operational test forms,
wherein the content of the supplemental forms comprises items selected from the group comprising:
(a) trend items for assessing trends in student academic achievement relative to predefined academic achievement standards;
(b) field test items being field tested for possible use on future operational test forms; and
(c) anchor items for equating the performance results of the students on the operational test forms with the performance results of a different group of students on a different operational test form, a portion of which are administered a supplemental test form containing the same anchor items.

14. The system of claim 13, wherein the content of each supplemental form comprises trend items, field test items, and anchor items.

15. The system of claim 13, wherein the content of each supplemental form comprises one of trend items, field test items, and anchor items.

16. A method for measuring academic achievement of students, comprising:
administering a common operational form to all students of a group of students to measure individual academic achievement each student; and
measuring academic achievement trends of the group of students by administering a set of items subdivided into supplemental forms comprised of unique subsets of the set of items, wherein different supplemental forms containing different unique subsets of items are administered to different subgroups of the group of students to derive academic achievement trends for the group of students based on the entire set of items.
